(19) United States
(12) Patent Application Publication
(10) Pub. No.: US 2012/0279528 A1
(43) Pub. Date: Nov. 8, 2012

(54) Device for Wetting a Bulk Good

(76) Inventors: Mario Dikty, Apensen (DE); Dominik Deimel, Stade (DE); Carsten Greiser, Hamburg (DE)

(21) Appl. No.: 13/521,116

(22) PCT Filed: Jan. 19, 2010
(86) PCT No.: PCT/EP2010/000282

§ 371 Date: Jul. 9, 2012

(51) Int. Cl. B08B 3/04

(52) U.S. Cl. 134/133

(57) ABSTRACT

A device for wetting a bulk good, in particular for moistening power plant filter ashes, comprises a downpipe. An inlet, through which the bulk good enters the downpipe, is formed at the upper end of the downpipe. An outlet, through which the bulk good is discharged in the wetted state, is formed at the lower end of the downpipe. A water supply to the downpipe is provided. The downpipe has a flexible wall section. The water supply opens into the flexible wall section of the downpipe. Deposits of the bulk good are prevented in that the bulk good does not come in contact with water until the bulk good is in the flexible wall section.

### BACKGROUND

The invention relates to a device for humidifying a bulk material, in particular for humidifying power plant filter ash. The device includes a downpipe. An inlet, through which the bulk material enters into the downpipe, is realized at the top end of the downpipe. An outlet, through which the bulk material exits in the humidified state, is realized at the bottom end of the downpipe. A water supply is provided to the downpipe, and the downpipe has a flexible wall portion.

There are bulk materials which tend to form dust in the dry state. Included here, for example, is ash, as is created during the operation of a power plant. If the bulk material has to be disposed of out of the power plant, the surrounding area can become impaired in a considerable manner by the dust that is created. It is known that the formation of dust in the case of said bulk materials can be reduced by means of humidification, see for example DE 41 27 447 and DE 197 42 334. It has been shown, however, that the bulk material, when it is mixed with water, tends to adhere to the inside wall of the downpipe and be deposited there.

DE 41 27 447 proposes several measures to combat the depositing of the humidified bulk material. Thus, the bulk material is set in rotation before the water is supplied. In addition, a scraper is provided in the downpipe in order to remove deposits again which form in spite of the rotation of the bulk material. Finally, the wall in a bottom portion of the downpipe consists of a flexible material. The flexible material is kept in motion by the bulk material flow such that the bulk material is not able to be fixed there. A plurality of measures such as these is susceptible to errors and requires regular maintenance.

### SUMMARY

A device for humidifying bulk materials is provided. The device is simple in design and does not have any bulk material deposited in the downpipe. The supply opens out in the flexible wall portion of the downpipe.

First of all, some terms are explained. The term flexible wall portion refers to a portion of the downpipe in which the wall of the downpipe comprises a flexible material. The flexible material can be set in elastic motion by the forces which arise during the operation of the device.

The term water in conjunction with the humidifying of the bulk material is representative of all liquids which reduce the development of dust when they are supplied to the bulk material. Fresh water, waste water and non-filtered water are included. Liquids in which the main constituent is one other than water are also included. Solids, for example suspended matter, can be contained in the water.

By the water supply opening out in the flexible wall portion of the downpipe, the operation of the humidifying takes place precisely where the wall of the downpipe is set into movement by the flow of bulk material. The bulk material, however, is able to collect to a small extent on the moving wall of the downpipe.

The risk of deposits is not limited to the region of the downpipe in which the water is supplied. Rather, the bulk material can also be deposited further down in the downpipe where no more water is supplied. In order to prevent said deposits, it can be provided that the flexible wall portion extends from the water supply as far as up to the outlet of the downpipe. The bulk material then covers its entire path after humidification in a portion of the downpipe in which the wall is flexible.

The water supply can open out in a single opening in the flexible wall portion of the downpipe. The water supply preferably opens out in a plurality of nozzles. The term nozzle refers generally to a mouth through which water can enter into the downpipe. Using a plurality of nozzles, in the case of a suitable arrangement it can be achieved that the water contacts the bulk material flow from several directions and as a result the bulk material is evenly humidified. The nozzles can be arranged on one plane of the downpipe. The nozzles can be located opposite each other in pairs or can be equally distributed over the circumference of the downpipe. Embodiments where the nozzles are arranged at different heights in the downpipe are also included. For example, the nozzles can be distributed on several planes in the wall of the downpipe. The nozzles can be aligned perpendicularly with respect to the wall of the downpipe or can open out into the downpipe at an angle.

For even humidification of the bulk material, the nozzles can be realized as fan jet nozzles such that the water jet is expanded in one dimension transversely with respect to its direction of movement. The fan jet can be aligned parallel, transversely or inclinedly with respect to the flow of bulk material. The alignment of all the fan jet nozzles can be the same. Different alignments are also possible such that, for example, part of the fan jet nozzles is aligned parallel and another part is aligned transversely with respect to the flow of bulk material.

The nozzles can be arranged fixed in position or can be rigidly connected together. The freedom of movement of the flexible wall of the down pipe is then limited by the nozzles. Movement of the flexible wall is only possible in the region between the fixedly arranged nozzles. As an alternative to this, it can be provided that the nozzles are connected to the flexible wall portion independently of one another. Movements of the nozzles in relation to one another are then possible such that the flexible wall of the downpipe has a greater freedom of movement. The probability of deposits of bulk material is reduced further by this measure.

Flexible lines can be provided in order to supply water to the nozzles. The freedom of movement of the nozzles is retained by using flexible lines. The flexible lines can be fed, for example, from a ring-shaped line which extends around the downpipe.

As few holding points for deposits as possible are to be presented to the bulk material in the interior of the downpipe. The inside wall of the downpipe is preferably smooth for this reason. If a portion in which the wall of the downpipe is rigid connects to the flexible wall portion—which is not absolutely necessary—, the transition between the rigid and the flexible wall portion should be as flush as possible. In an advantageous embodiment, the nozzles by means of which the bulk material is humidified are developed such that they do not project into the interior of the downpipe.

Apart from the mentioned nozzles by means of which the bulk material flow is humidified, cleaning nozzles can be arranged in the downpipe. Deposits and contaminants which become fixed in spite of the humidification carried out as claimed in the invention can be removed again by means of the cleaning nozzles. The cleaning nozzles are developed such that they project into the interior of the downpipe. The cleaning nozzles are preferably aligned such that the water contacts the inside wall of the downpipe at an acute angle of less than 45°. Contaminants and deposits are lifted off the inside wall of the downpipe as a result and are removed.

The cleaning nozzles can be realized as sluice nozzles, in which the water is deflected such that it contacts the inside wall of the downpipe at a suitable angle. A deflecting surface can be provided for this purpose in the extension of the nozzle axis, the water jet contacting said deflecting surface and as a result obtaining another direction.

As elements projecting into the downpipe always form holding points for deposits of the bulk material, the cleaning nozzles are preferably arranged in a portion of the downpipe in which the risk of deposits is low. This is the case wherever the bulk material flow is still dry, that is to say above the water nozzles by means of which the bulk material is humidified. The cleaning nozzles can be arranged in the flexible wall portion of the downpipe. It is also possible for the cleaning nozzles to be arranged in a rigid portion of the downpipe which connects to the flexible portion.

The material of the flexible wall portion can be a rubber material. The material must not be so flexible that the bulk material flow is impeded by the movement of the material. In order to ensure sufficient stability, reinforcements can be provided for the rubber material. The reinforcement can, for example, be a wire that extends in a spiral-shaped manner through the rubber material.

It is possible for the bulk material to be stored in a container above the downpipe and to fall out of the container into the downpipe. In an alternative embodiment, the bulk material is supplied to the downpipe in a fluidized state. For this purpose, fluidizing elements can be arranged at the outlet of the container, by means of which fluidizing elements a fluidized gas is supplied to the bulk material. A bulk material supplied in a fluidized state can be humidified in a simpler manner.

### BRIEF DESCRIPTION OF THE DRAWINGS

The invention is described below by way of advantageous embodiments with reference to the attached drawings, in which:

FIG. 1 shows a schematic representation of a device;

FIGS. 2 and 3 show downpipes in the case of other embodiments; and

FIGS. 4 to 6 show cutouts of the flexible wall portions in the case of different embodiments.

### DETAILED DESCRIPTION

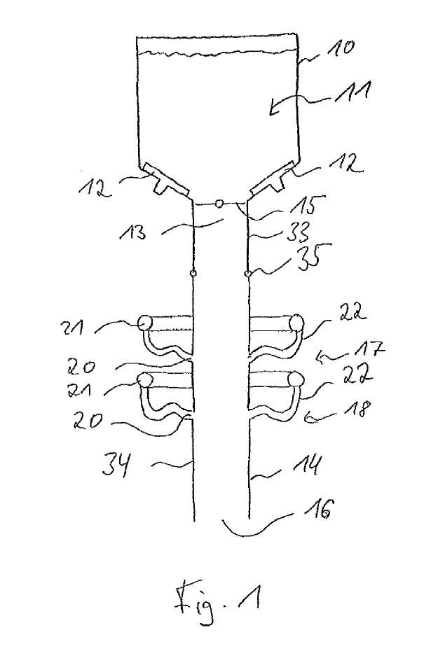

A device shown in FIG. 1 includes a hopper 10 which is filled with a bulk material 11. The bulk material is ash which is created during the operation of a power plant. Fluidizing elements 12 are arranged at the bottom end of the hopper 10. Air can be directed into the bulk material 11 by the fluidizing elements 12 such that the bulk material 11 is set into a fluidized state.

The hopper 10 merges by way of its bottom end into a downpipe 14 which is arranged in a perpendicular manner. The outlet of the hopper 10 forms at the same time the inlet 13 of the downpipe 14. A closure 15 which is represented in the closed state in FIG. 1 is realized at the transition from the hopper 10 to the downpipe 14. In the closed state, the closure 15 prevents the bulk material 11 from being able to escape from the hopper 10. The the closure 15 therefore closes the hopper 10 off downward. If the closure 15 is open, the bulk material 11 can enter into the downpipe 14 in the fluidized state. From the region of the inlet 13, the bulk material falls downward until it escapes through the outlet 16 out of the downpipe 14.

The downpipe 14 is divided into a top portion 33 and a bottom portion 34. In the top portion 33 the wall of the downpipe 14 comprises steel, that is to say a non-flexible material. A closable opening (not shown), which enables access to the interior of the downpipe 14 for the purposes of inspection and cleaning, is realized in the top portion 33. In order to prevent deposits of the bulk material, the inside wall of the downpipe 14 is smooth in the top portion 33 and provided with a non-stick coating.

In the bottom portion, the flexible wall portion 34, the wall of the downpipe 14 comprises rubber which is reinforced with a spiral-shaped wire insert. The reinforced rubber is a flexible material. At 35 the steel of the top portion 33 and the rubber of the flexible wall portion 34 are connected together in a suitable manner. In an advantageous embodiment, the steel and the rubber material are connected to each other in a flush manner such that the inside wall of the downpipe 14 is smooth in the transition region. As an alternative to this, the rubber material can be connected in a simple manner to the top portion 33 by being placed on the outside and being secured by way of a clamp.

Eight nozzles 20, which are only represented schematically in FIG. 1 as openings in the wall of the downpipe 14, are arranged in each case on a first plane 17 and a second plane 18 in the flexible wall portion 34 of the downpipe 14. The nozzles 20 are fan jet nozzles which are aligned onto the center of the downpipe 14 in the radial direction and are inclined downward slightly in relation to the horizontal. The nozzles 20 are equally distributed over the circumference in each case on the planes 17 and 18.

An annular pipe 21 which surrounds the downpipe 14 is provided for each of the planes 17, 18. Connecting lines 22 extend in each case from the water nozzles 20 to the associated annular pipe 21. The connecting lines 22 comprise a flexible material. Therefore, they are not rigid. The annular pipes 21 are supplied with water by a supply line (not shown) which is pressurized. The water can be waste water, in a power plant, for example, the waste water of a flue gas desulphurization system. The water passes via the annular pipes 21 and the flexible connecting lines 22 to the water nozzles 20 and from there enters into the downpipe 14 where it contacts the bulk material flow falling through the downpipe 15. The water penetrates into the bulk material flow and at the same time mixes with the bulk material flow. The water contacting the bulk material flow from different directions on the planes 17, 18 ensures that the bulk material is completely humidified before it exits through the outlet 16 of the downpipe 14.

Through the water emerging from the nozzles 20 and the bulk material flow which moves through the downpipe 14, a force acts on the rubber material of the flexible wall portion 34. The rubber material is selected such that it is set in motion by said forces. The movement is strong enough to prevent the bulk material being deposited, but not so strong that the movement of the bulk material is impaired. As the nozzles 20 are connected to the annular pipes 21 by means of flexible connecting lines 22, the nozzles 20 can move together with the flexible wall of the downpipe 14. The mobility of the flexible wall portion 34 is only restricted by the nozzles 20 in an insignificant manner.

In the device, the bulk material flow can move through the entire downpipe 14 without any deposits occurring. In the top portion 33, in which the wall of the downpipe 14 is of steel, the bulk material is still dry and as a result is not deposited. The bulk material first comes into contact with water in the flexible wall portion 34, there is no depositing here on account of the movement of the wall.

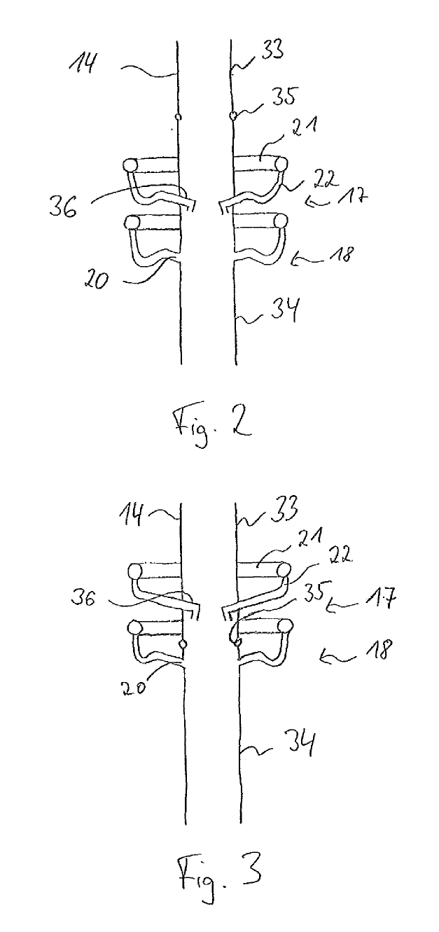

In FIG. 2, only the nozzles 20 of the bottom plane 18 are used for humidifying the bulk material. So much water exits the nozzles 20 of the plane 18 that the bulk material is completely and evenly humidified. The nozzles of the top plane 17 are realized as cleaning nozzles 36 by way of which deposits, which have formed in spite of the movement in the flexible wall portion 34, are able to be removed again. The cleaning nozzles 36 project into the interior of the downpipe 14 and are realized as so-called sluice nozzles, where a deflecting surface is arranged in the extension of the nozzle axis. The water jet contacts the deflecting surface and is deflected downward in the form of a fan jet.

If deposits have formed in the flexible wall portion 34, the bulk material flow and the water supply to the nozzles 20 are interrupted. The cleaning nozzles 36 are then set in operation in order to remove the deposits again. The water jet emerging from the cleaning jets 36 contacts the wall of the downpipe 14 at an angle of approximately 30° and lifts the deposits off. Once the deposits have been removed, the device can be put back into operation properly again and be used for humidifying the bulk material.

In the embodiment in FIG. 3, once again only the nozzles 20 of the bottom plane 18 are used for humidifying the bulk material, whilst the nozzles of the top plane 17 are realized as cleaning nozzles 36. Contrary to the embodiment in FIG. 2, both planes 17, 18 are not arranged in the flexible wall portion 34, just the nozzles of the bottom plane 18. The cleaning nozzles 36 are arranged in the top portion 33 of the downpipe 14 in which the wall consists of a rigid material. As movement of the cleaning nozzles 36 is not desired, the connecting lines 22 between the cleaning nozzles 36 and the annular pipe 21 can also be rigid.

In the case of many bulk materials, it is sufficient for a complete and even humidifying of the bulk material when a plurality of nozzles 20 is arranged on one plane 18. Neither additional nozzles on another plane nor cleaning nozzles are urgently necessary to the invention.

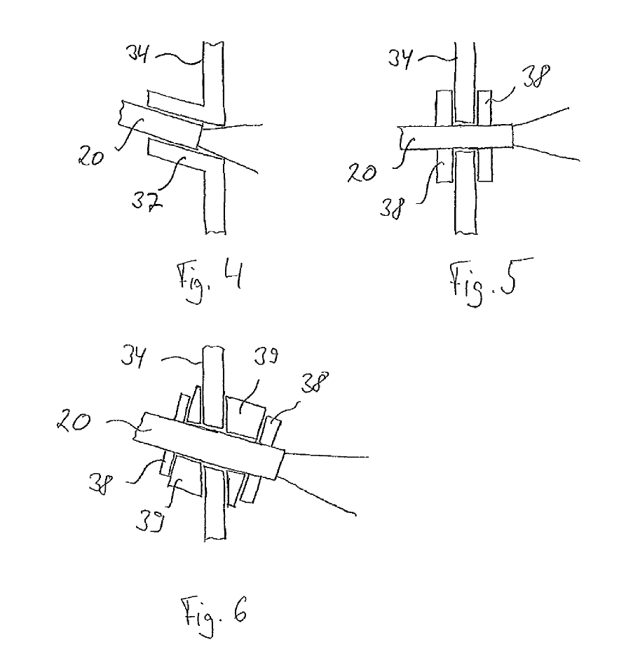

FIGS. 4 to 6 show cutouts from the flexible wall portion 34 in the case of different embodiments. In FIG. 4 a hose-shaped attachment 37 is realized directly in the rubber material of the flexile wall portion 34. A nozzle 20 is inserted into the hose-shaped attachment 37 and is fixed in the suitable position using a hose clip (not shown).

In FIG. 5 just one bore is provided in the rubber material of the flexible wall portion 34 for the reception of the nozzle 20. The nozzle 20, the outside surface of which is provided with a thread, is inserted into the bore and fixed in the correct position using two nuts 38. The nozzle 20 projects into the downpipe 14 and is aligned at a right angle with respect to the wall of the downpipe 14.

In FIG. 6, the nozzle 20 is also fixed using two nuts 38. The water nozzle 20 obtains an inclined alignment in relation to the wall of the downpipe 14 by means of wedge-shaped intermediate parts 39. The contour of the intermediate parts 39 is adapted to the flexible wall portion 34.

1. A device for humidifying a bulk material, in particular for humidifying power plant filter ash, said device including a downpipe, at the top end of which is realized an inlet through which the bulk material enters into the downpipe, and at the bottom end of which is realized an outlet through which the bulk material exits in the humidified state, wherein a water supply is provided to the downpipe and wherein the downpipe has a flexible wall portion, characterized in that the water supply opens out in the flexible wall portion of the downpipe.

2. The device as claimed in claim 1, characterized in that the flexible wall portion extends from the water supply as far as up to the outlet of the downpipe.

3. The device as claimed in claim 1, characterized in that the water supply includes a plurality of nozzles opening out into the downpipe.

4. The device as claimed in claim 3, characterized in that the nozzles are connected to the flexible wall portion independently of each other.

5. The device as claimed in claim 3, characterized in that flexible lines are provided in order to supply water to the nozzles.

6. The device as claimed in claim 3, characterized in that a plurality of nozzles is arranged on one plane.

7. The device as claimed in claim 3, characterized in that the nozzles do not project into the interior of the downpipe.

8. The device as claimed in claim 1, characterized in that cleaning nozzles are provided which project into the interior of the downpipe.

9. The device as claimed in claim 8, characterized in that the cleaning nozzles are arranged in the flexible wall portion of the downpipe.

10. The device as claimed in claim 1, characterized in that the wall of the downpipe in the flexible wall portion comprises a rubber material.

11. The device as claimed in claim 10, characterized in that the rubber material is reinforced by an insert.

12. The device as claimed in claim 2, characterized in that the water supply includes a plurality of nozzles opening out into the downpipe.

13. The device as claimed in claim 4, characterized in that flexible lines are provided in order to supply water to the nozzles.

14. The device as claimed in claim 4, characterized in that a plurality of nozzles is arranged on one plane.

15. The device as claimed in claim 5, characterized in that a plurality of nozzles is arranged on one plane.

16. The device as claimed in claim 4, characterized in that the nozzles do not project into the interior of the downpipe.

17. The device as claimed in claim 5, characterized in that the nozzles do not project into the interior of the downpipe.

18. The device as claimed in claim 6, characterized in that the nozzles do not project into the interior of the downpipe.

19. The device as claimed in claim 2, characterized in that cleaning nozzles are provided which project into the interior of the downpipe.

20. The device as claimed in claim 3, characterized in that cleaning nozzles are provided which project into the interior of the downpipe.
